(19) United States
(12) Patent Application Publication
(10) Pub. No.: US 2025/0008179 A1
(43) Pub. Date: Jan. 2, 2025

(54) METHOD, APPARATUS, DEVICE, MEDIUM AND PROGRAM FOR SWITCHING VIDEO

(71) Applicant: Beijing Zitiao Network Technology Co., Ltd., Beijing (CN)

(72) Inventors: Chuncheng WANG, Beijing (CN); Liyue JI, Beijing (CN); Xinkai ZHOU, Beijing (CN); Xiangxin LIU, Beijing (CN)

(21) Appl. No.: 18/758,581

(22) Filed: Jun. 28, 2024

(30) Foreign Application Priority Data
Jun. 28, 2023 (CN) 202310777334.9

(51) Int. Cl. H04N 21/431; G06T 17/00

(52) U.S. Cl. CPC H04N 21/4316; G06T 17/00

(57) ABSTRACT

Embodiments of the present application provide a method, apparatus, device, medium and program for switching video. The method comprises: displaying a first playing window of a 2D application in a virtual reality space, a first 2D video being played in the first playing window; and in response to a first video switching instruction, determining a switched video as a virtual reality (VR) video, and playing the VR video through a second playing window, the second playing window having a larger area than the first playing window. The method can recommend VR videos to a user through a playing window of 2D video of a 2D application and, based on a first video switching instruction, can switch to a playing window of a VR video to play the VR video, so that the user can quickly switch to the VR video in the 2D application, bringing the user a better experience.

### CROSS-REFERENCE TO RELATED APPLICATION(S)

This application claims priority to Chinese Application No. 202310777334.9 filed in Jun. 28, 2023, the disclosure of which is incorporated herein by reference in its entity.

### FIELD

Embodiments of the present application relate to the technical field of electronic devices, and in particular, to a method, apparatus, device, storage medium and program for switching video.

### BACKGROUND

Extended Reality (XR) is the combination of the reality and the virtuality through computers to create a virtual environment that allows human-computer interaction, and XR XR is also an umbrella term for a variety of technologies such as Virtual Reality (VR), Augmented Reality (AR) and Mixed Reality (MR). By combining the three visual interaction technologies, the experience of seamless “immersion” between the virtual world and the real world is brought about to experiencers.

Currently in XR devices, users can use traditional 2D applications, for example, watch short videos using traditional 2D short video applications. However, 2D short video applications only support playing 2D video and do not support 3D video (i.e., VR video). Users, if having a demand for VR video playback, can only switch to other 3D applications for viewing. Therefore, the user experience is not good.

### SUMMARY

The embodiments of the present disclosure provide a method, apparatus, device, medium and program for switching video, which can recommend VR video to a user through a playing window of 2D video of a 2D application, so that the user can quickly switch to the VR video in the 2D application, bringing the user a better experience.

In a first aspect, an embodiment of the present disclosure provides a method for switching video, comprising:
displaying a first playing window of a 2D application in a virtual reality space, a first 2D video being played in the first playing window; and
in response to a first video switching instruction, determining a switched video as a virtual reality (VR) video, and playing the VR video through a second playing window, the second playing window having a larger area than the first playing window.

In some embodiments, playing the VR video through the second playing window comprises:
displaying the VR video in a full screen within the second playing window.

In some embodiments, playing the VR video through the second playing window comprises:
superimposing and displaying the first playing window on the second playing window, and playing the VR video within the second playing window, wherein a content of the VR video located within an area covered by the first video playing window is displayed through the first playing window and a remaining content is displayed within the second playing window, and the second playing window has a less transparency than the first playing window.

In some embodiments, superimposing and displaying the first playing window superimposed on the second playing window comprises:
generating a masked image based on a location and a size of the first playing window, an effective area of the masked image being an area corresponding to the first playing window, an image within the effective area being fully displayed, and an image outside the effective area being displayed semi-transparently; and
displaying the VR video played within the second playing window after superimposing the masked image and the second playing window.

In some embodiments, a recommendation control for VR videos is further displayed in the virtual reality space, and in response to the first video switching instruction, determining the switched video as the VR video and playing the VR video through the second playing window comprises:
in response to a first operation on the recommendation control for VR videos, determining the switched video is a virtual reality VR video, and playing the VR video through the second playing window.

In some embodiments, there is further comprised:
in response to a full-screen playing instruction, controlling the first playing window to disappear, the VR video being played in a full screen within the second playing window after the first playing window disappears.

In some embodiments, a full-screen playing control is displayed within the first playing window, and in response to the full-screen playing instruction, controlling the first playing window to disappear comprises:
in response to a second operation on the full-screen playing control, controlling the first playing window to disappear.

In some embodiments, controlling the first playing window to disappear comprises:
controlling the first playing window to gradually increase until a boundary of the first playing window exceeds a boundary of the second playing window, and the first playing window disappearing, and wherein an area of the VR video displayed within the first playing window gradually increases in the process of increasing the first playing window.

In some embodiments, there is further comprised:
in response to a full-screen exit instruction, superimposing and displaying the first playing window on the second playing window.

In some embodiments, a full-screen exit control is displayed within the second playing window, and in response to the full-screen exit instruction, superimposing and displaying the first playing window on the second playing window comprises:
in response to a third operation on the full-screen exit control, controlling the first playing window to appear and to be superimposed on the second playing window.

In some embodiments, in response to the full-screen exit instruction, superimposing and displaying the first playing window on the second playing window comprises:
in response to the full-screen exit instruction, based on a target location and target size of the first playing window, controlling the first playing window to gradually reduce to the target size and the target location from a boundary of the second playing window, and wherein an area of the VR video displayed within the first playing window gradually reducing in a process of reduces the first playing window.

In some embodiments, there is further comprised:
in response to a shape transformation operation on the first playing window, transforming a shape of the first playing window.

In some embodiments, the following information is displayed inside and/or outside a border of the first playing window: information of a currently displayed video, information of the 2D application and video recommendation information.

In some embodiments, the following information is displayed inside and/or outside a border of the first playing window within a first preset time of the start of playing of the VR video: information of the VR video, information of the 2D application, video recommendation information and a full-screen playing control, and the video recommendation information and the full-screen playing control are displayed inside and/or outside the border of the first playing window after the first preset time finishes.

In some embodiments, there is further comprised:

in response to the first video switching instruction, determining a switched video as a second 2D video, and playing the second 2D video through the second playing window.

In some embodiments, there is further comprised:
in response to a second video switching instruction, determining a switched video as a VR video, and playing a switched target VR video through the second playing window.

In some embodiments, there is further comprised:
in response to a second video switching instruction, determining a switched video as a 2D video, and closing the second playing window, and playing a switched third 2D video through the first playing window.

In another aspect, an embodiment of the present disclosure provides an apparatus for playing a video, comprising:
a displaying module configured to display a first playing window of a 2D application in a virtual reality space, a first 2D video being played in the first playing window; and
a switching module configured to determine a switched video as a virtual reality VR video in response to a first video switching instruction, and play the VR video through a second playing window, wherein the second playing window has a larger area than the first playing window.

In a further aspect, an embodiment of the present disclosure provides an electronic device, comprising: a processor and a memory, the memory storing a computer program, the processor being for invoking and running the computer program stored in the memory to perform the method as described above.

In a yet further aspect, an embodiment of the present disclosure provides a computer readable storage medium, storing a computer program thereon, the computer program causing the computer to perform the method as described above.

In a yet further aspect, an embodiment of the present disclosure provides a computer program product, comprising a computer program, wherein the computer program, when executed by a processor, implements the method as described above.

In the method, apparatus, device, medium and program for switching video provided by the embodiments of the present disclosure, the method comprises: displaying a first playing window of a 2D application in a virtual reality space, a first 2D video being played in the first playing window; and in response to a first video switching instruction, determining a switched video as a virtual reality (VR) video, and playing the VR video through a second playing window, the second playing window having a larger area than the first playing window. The method can recommend VR video to a user through a playing window of 2D video of a 2D application, switch a playing window of the VR video to play the VR video based on a first video switching instruction, so that the user can quickly switch to the VR video in the 2D application, bringing the user a better experience.

### BRIEF DESCRIPTION OF THE DRAWINGS

To illustrate the embodiments of the present disclosure or the technical solutions in the prior art more clearly, a brief introduction is presented below to the drawings to be used in the embodiments or the description of the prior art. It is obvious that for those of ordinary skill in the art, they may further derive other drawings from these accompanying drawings without the exercise of any inventive skill.

FIG. 1 is a flowchart of a method for switching video provided by a first embodiment of the present disclosure;

FIG. 2 is a schematic diagram of a first playing window of a 2D application displayed in a virtual reality space;

FIG. 3 is a schematic diagram of one user interface after the 2D video shown in FIG. 2 is switched to a VR video;

FIG. 4 is a schematic diagram of another user interface after the 2D video shown in FIG. 2 is switched to a VR video;

FIG. 5 is a schematic diagram of the first playing window after shape adjustment;

FIG. 6 is a flowchart of a method for switching video provided by a second embodiment of the present application;

FIG. 7 is a schematic diagram of the interface change after the VR video is switched to full-screen playing in a second playing window;

FIG. 8 is a flowchart of a method for switching video provided by a third embodiment of the present application;

FIG. 9 is a structural schematic diagram of an apparatus for switching video provided by a fourth embodiment of the present application; and

FIG. 10 is a structural schematic diagram of an electronic device provided by a fifth embodiment of the present application.

### DETAILED DESCRIPTION OF EMBODIMENTS

A clear and complete description is presented below to the technical solution in the embodiments of the present disclosure in conjunction with the accompanying drawings therein. It is apparent that the embodiments to be described are merely part of rather than all of the embodiments of the present disclosure. All other embodiments obtained by those of ordinary skill in the art without the exercise of inventive skill based on the embodiments of the present disclosure fall within the protection scope of the present disclosure.

It is to be noted that the terms “first”, “second” and the like in the specification, the claims and the accompanying drawings in the present invention are for differentiating similar objects, rather than for describing a specific order or sequence. It should be understood that the data used as such may be interchanged in appropriate cases, so that the embodiments of the present disclosure described herein can be implemented in other sequences than those depicted or described herein. In addition, the terms “comprise”, “have” as well as their variants are intended to cover non-exclusive inclusion. For example, processes, methods, systems, products or servers including a series of steps or units do not have to be limited to those clearly listed steps or units, but may include other steps or units that are not clearly listed or are inherent to those processes, methods, products, or devices.

To facilitate the understanding of the embodiments of the present disclosure, first of all, some concepts involved in all the embodiments of the present disclosure will be properly explained before describing respective embodiments of the present disclosure.

1) Virtual Reality (abbreviated as VR), the technology of creating and experiencing virtual worlds, determines the generation of a virtual environment, is multi-source information (virtual reality mentioned herein includes at least visual perception, and may further include auditory perception, tactile perception, motion perception, and even taste perception, olfactory perception, etc.), and achieves the integration of virtual environments, interactive three-dimensional dynamic views and simulation of entity behavior, so that the user is immersed in the simulated virtual reality environment. VR is implemented in applications in a wide range of virtual environments such as mapping, gaming, video, education, healthcare, simulation, co-training, sales, assisted manufacturing, maintenance and repair.

2) Virtual reality devices (VR devices), which are terminals achieving virtual reality effects, can typically be provided in the form of glasses, head mounted displays (HMDs) and contact lenses for visual perception and other forms of perception. Of course, the implementation form of virtual reality devices is not limited thereto, and virtual reality devices can be further miniaturized or enlarged as needed.

Optionally, the virtual reality devices described in the embodiments of the present disclosure can include, without limitation to, the following types:

2.1) PC-based virtual reality (PCVR) devices that utilize the PC to perform calculations related to virtual reality functions and data output, and external PC-based virtual reality devices that utilize the data output from the PC to achieve virtual reality effects.

2.2) Mobile virtual reality devices that support setting mobile terminals (such as smartphones) in various ways (such as a head-mounted display that is provided with a specialized card slot). Through wired or wireless connections with the mobile terminal, the mobile terminal performs calculations related to virtual reality functions and outputs data to the mobile virtual reality device, such as watching virtual reality video through APPs on the mobile terminal.

2.3) All-in-one virtual reality devices with a processor for performing calculations related to virtual functions, thus having independent virtual reality input and output functions, without the need to connect to a PC or mobile terminal, and with a high degree of freedom of use.

3) Mixed reality (abbreviated as MR): combines the real and virtual worlds to create new environments and visualizations, where physical entities and digital objects coexist and can interact with each other in real time to simulate real objects. Reality, augmented reality, augmented virtuality and virtual reality technologies are mixed. MR is a virtual reality (VR) plus augmented reality (AR) synthetic product mixed reality (MR), is the expansion of virtual reality (VR) technology, and can increase the real sense of user experience by presenting the virtual scene in the real scene. The field of MR relates to computer vision. The computer vision is a science that studies how to make machines “see”, and furthermore, refers to machine vision in which cameras and computers replace human eyes in recognizing, tracking, and measuring targets, and furthermore, performs image processing, i.e., processing images into ones that are more suitable for the human eyes to observe or transmit to instruments for detection.

That is, MR is a simulation set that integrates computer-created sensory input (e.g., virtual objects) with sensory input from a physical set or a representation thereof. In some MR sets, computer-created sensory input can be adapted to variations in sensory input from the physical set. In addition, some electronic systems for presenting MR sets can monitor orientations and/or locations relative to the physical set, so that the virtual object can interact with the real object (i.e., physical element from the physical set or a representation thereof). For example, the system can monitor motion, so that the virtual plant seems to be stationary relative to the physical building.

After introducing some of the concepts involved in the embodiments of the present application, a method for switching video provided by an embodiment of the present disclosure will be described in detail with reference to the accompanying drawings. Regarding the same content, reference may be made to the foregoing description of the embodiments, which will not be repeated.

FIG. 1 is a flowchart of a method for switching video provided by a first embodiment of the present application. The method in this embodiment of the present application is performed by a VR device, which can be implemented as an XR device such as a VR device, an AR device, an MR device and so on. As shown in FIG. 1, the method for switching video comprises the following.

In S101, a first playing window of a 2D application is displayed in a virtual reality space, a first 2D video being played in the first playing window.

A 2D application can also be opened in the virtual reality space (also known as extended reality space or virtual scene) provided by the XR device. The 2D application is an application that traditionally runs on electronic devices such as cell phones, computers, tablets, etc. The screen presented by the 2D application to the user is a 2D image. The 2D application is relative to a 3D application, and the content presented by the 3D application to the user is a 3D image. The 2D application includes, but is not limited to, a video playing application, a short video application, a music application, an instant messaging application, shopping software, etc.

Take the short video application as an example. The user can open a 2D short video application under a 3D desktop environment and plays the short video. After the user opens the 2D short video application, a first playing window of the 2D short video application is displayed in the virtual reality space. The first playing window can be understood as being carried on a virtual screen that is used to display 2D applications.

Videos recommended to the user in traditional 2D short video applications are all 2D videos. In this embodiment, the 2D short video application can recommend not only 2D videos to the user but also VR videos to the user. The VR video is a 3D video, so that the user can quickly switch to the VR video in the 2D application, and better experience is brought about to the user.

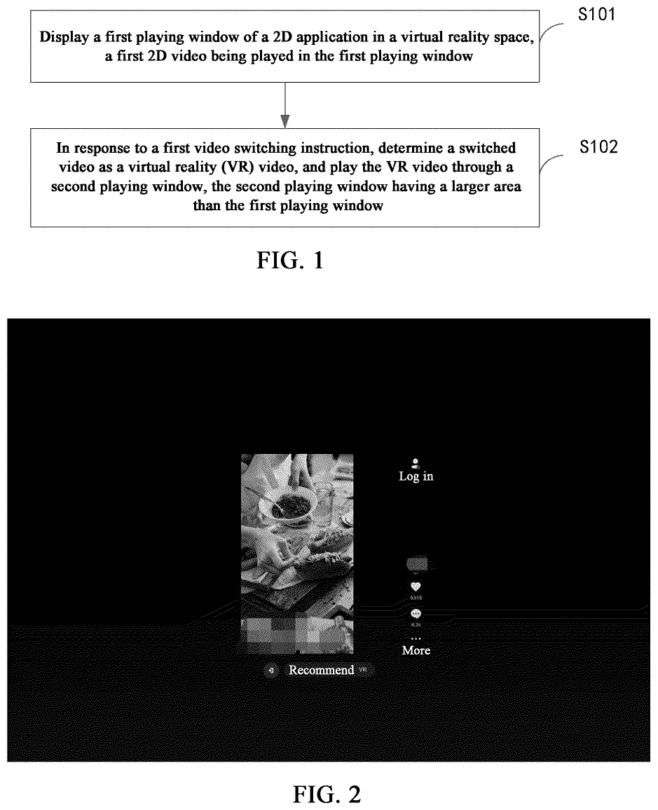

FIG. 2 is a schematic diagram of a first playing window of a 2D application displayed in a virtual reality space. As shown in FIG. 2, a first 2D video is played in the first playing window. When running the 2D application in the virtual reality space, a display window of the 2D application is usually a small window in the virtual reality space and will not fill up a display screen of the XR device. As shown in FIG. 2, the first playing window is located in the middle of the entire display screen and is smaller than the display screen.

Other area than the first playing window in the display screen is used as a background area, in which the following images may be displayed:

(1) A first image unrelated to content currently played in the first playing window is displayed in the background area. The first image may be a solid color background image, e.g., a solid white or solid black background image, and the first image may further be a non-solid color image.

(2) A second image related to content currently played in the first playing window is displayed in the background area. The second image may be a first frame image of the video currently played in the first playing window, or the second image may be a profile image of the video currently played in the first playing window.

(3) Content of an extended reality space is displayed in the background area. For example, the user opens a 2D short video application under a 3D desktop environment, at which point the 3D desktop environment is the background area.

The following information is displayed inside and/or outside the border of the first playing window: information of the video currently displayed, and information of the 2D application. With reference to FIG. 2, information of the first 2D video being current played is displayed inside the lower border of the first playing window, such as a name of a poster of the first 2D video, a brief description of the video, the music involved in the video, etc. Video recommendation information is displayed outside the lower border of the first playing window.

The video recommendation information is for recommending videos to the user, e.g., prompting the user that a VR video is available for watching. A login portal and video interaction controls are displayed outside the right border of the first playback window, such as a like control, a comment control, a share control, a follow control and the like for the video, to facilitate the user's interaction with the video of interest.

In S102, in response to a first video switching instruction, a switched video is determined as a VR video, and the VR video is played through a second playing window, the second playing window having a larger area than the first playing window.

In the 2D short video application, the user may switch between videos through a first video switching instruction. The first video switching instruction may be a switching instruction input through a handle of the XR device, a switching instruction generated through a click operation of interaction rays on a switching control on a user interface, or a switching instruction input by the user via gesture, voice or other apparatus.

For example, a recommendation control for VR videos is further displayed in the virtual reality space. The recommendation control may be displayed at a preset location in the first playing window, or further may be displayed in the virtual reality space outside the first playing window. The user performs a first operation on the recommendation control to switch between videos. The first operation includes, but is not limited to, clicking, double-clicking, long-pressing, or hovering on the recommendation control. Upon detecting the first operation on the recommendation control, the switched video is determined as a VR video, and the VR video is played through the second playing window.

According to the first video switching instruction, the XR device judges whether the switched video is a VR video or not. In this embodiment, a video type is added to each video in the 2D application, which is used to distinguish whether the video is a 2D video or a VR video. The video type may be added in a video link, and the XR device, after obtaining the video link, judges based on video type identification information in the video link whether the video is a VR video or not. As an example, the video type identification information is 0 and 1, wherein 0 represents a 2D video and 1 represents a VR video.

When the switched video is determined as a VR video, the VR video is then played through the second playing window. When the switched video is determined as a 2D video, the second 2D video after switch is played through the first video playing window.

The second playing window is for playing a VR video, and the first playing window is for playing a 2D video, the second playing window having a larger area than the first playing window. The second playing window is usually in a full screen, i.e., the second playing window fills up the entire display screen of the XR device. Therefore, the second playing window is also referred to as a full-screen playing window or a panorama playing window.

In a first mode, the VR video is played in a full screen through the second playing window; in a second mode, the first playing window is displayed in a way being superimposed on the second playing window, and the VR video screen is displayed within the second playing window, wherein a content of the VR video located within an area covered by the first video playing window is displayed through the first playing window and a remaining content is displayed within the second playing window, and the second playing window has a less transparency than the first playing window.

In the second mode, the VR video is substantially still played in the second playing window. The first playing window is equivalent to a transparent window, through which the user sees the content played in the second playing window through the transparent window. Other areas outside the transparent window are masked by a mask layer.

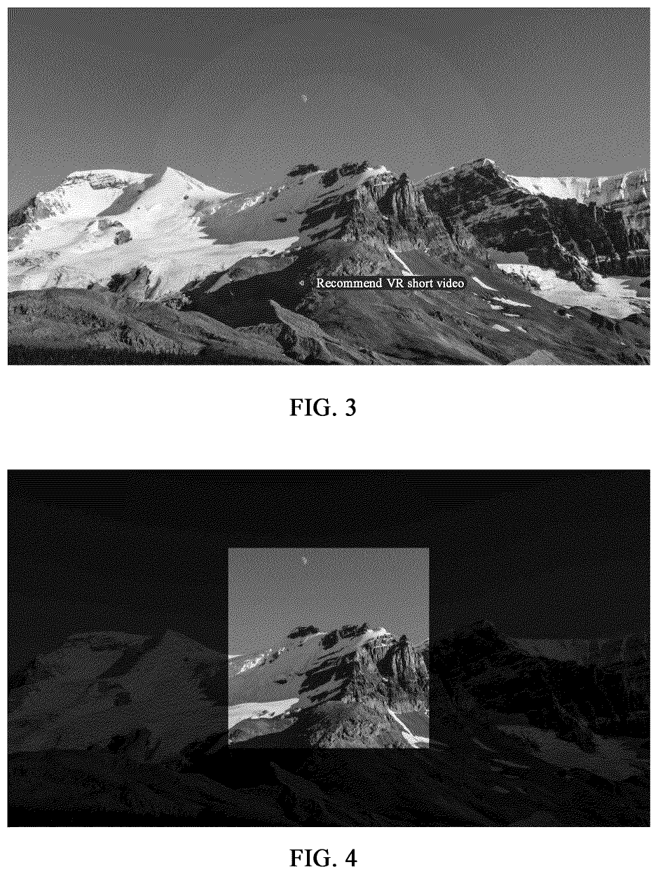

FIG. 3 is a schematic diagram of one user interface after a 2D video is switched to a VR video as shown in FIG. 2. The interface is an interface in which the second playing window plays the VR video in a full screen.

FIG. 4 is a schematic diagram of another user interface after a 2D video is switched to a VR video as shown in FIG. 2. The interface is a schematic diagram in which the first playing window is displayed in a way being superimposed on the second playing window. By displaying the first playing window superimposed on the second playing window, the first playing window is displayed in full transparency, and the second playback window is displayed in semi-transparency.

By displaying the first playing window superimposed on the second playing window, the user experience can be enhanced, and the first playing window can provide effects of using simulated human eyes, simulated boxes, simulated viewfinders, and simulated flashlights to see the world, bringing about better experience to the user and enhancing the user's desire for exploration.

Optionally, a shape of the first playing window can be adjusted, which may be a rectangle, square, circle, oval, etc. In response to a shape transformation operation on the first playing window, a shape of the first playing window is transformed.

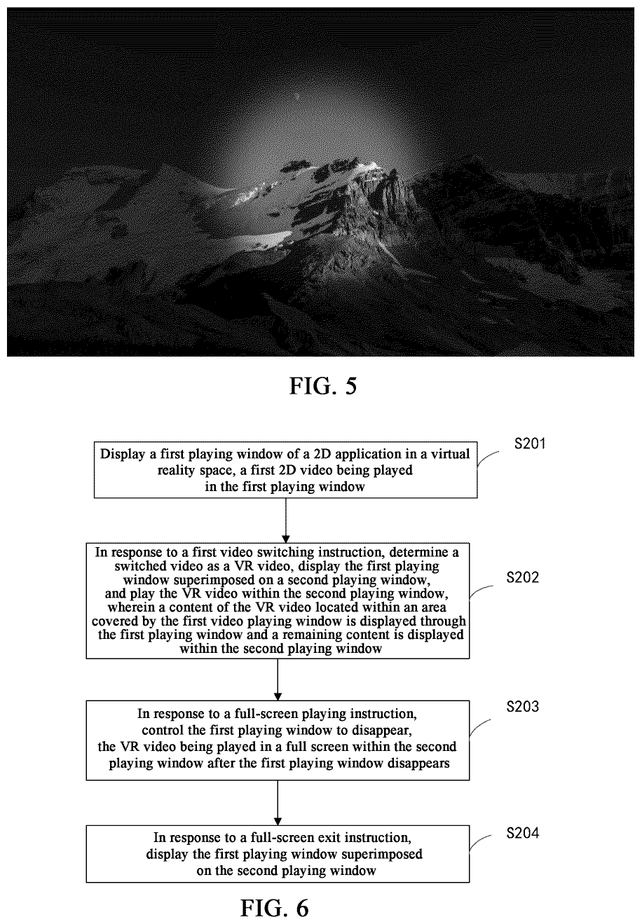

FIG. 5 is a schematic diagram of a first playing window whose shape has been adjusted. By comparing FIG. 4 and FIG. 5, it can be seen that the shape of the first playing window changes to an oval from a rectangle, and gradient effects are added outside the border of the oval first playing window.

In this embodiment, a first playing window of a 2D application is displayed in a virtual reality space, a first 2D video being played in the first playing window; in response to a first video switching instruction, a switched video is determined as a virtual reality (VR) video, and the VR video is played through a second playing window, the second playing window having a larger area than the first playing window. In this way, the VR video can be recommended to the user through the playing window of the 2D video of the 2D application, and in response to the first video switching instruction, it is possible to switch to the playing window of the VR video for playing the VR video. Therefore, the user can quickly switch to the VR video in the 2D application, and better experience is brought about to the user.

On the basis of the first embodiment, FIG. 6 is a flowchart of a method for switching video provided by a second embodiment of the present disclosure. As shown in FIG. 6, the method provided by this embodiment comprises the following.

In S201, a first playing window of a 2D application is displayed in a virtual reality space, a first 2D video being played in the first playing window.

In S202, in response to a first video switching instruction, a switched video is determined as a VR video, the first playing window is displayed in a way of being superimposed on a second playing window, and the VR video screen is played within the second playing window, wherein a content of the VR video located within an area covered by the first video playing window is displayed through the first playing window and a remaining content is displayed within the second playing window, and the second playing window has a less transparency than the first playing window.

A video within the first playing window is displayed normally, and a video within the second playing window is displayed translucently.

In one implementation, a masked image is generated based on a location and a size of the first playing window, an effective area of the masked image being an area corresponding to the first playing window; and the masked image is displayed after being superimposed on the VR video played in the second playing window.

The location of the first playing window refers to a location of the first playing window in the display screen of the CR device. The first playing window is located at a preset location in the display screen, and the location of the first playing window may be moved or set by the user.

The masked image, also known as a mask layer, can be understood as a mask added to the image, through which can show or hide a certain part or all of the image can be shown or hidden. The masked image comprises an effective area and an ineffective area. The effective area refers to an area which is not masked, and the ineffective area refers to an area which is masked. In this embodiment, the effective area refers to an area corresponding to the first playing window, and the ineffective area refers to an area other than the area corresponding to the first playing window.

In short, the masked image is filled with three colors: black, white and grey, where the black means fully masked, the white means fully displayed, and the grey means translucently displayed (i.e., partly hidden and partly visible).

A size of the masked image is the same as that of the second playing window. Usually, the second playing window plays in a full screen, i.e., the size of the second playing window is the same as that of the display screen. The masked image is displayed after being superimposed on the second playing window, and the VR video is played within the second playing window. The effects of superimposed display are as shown in FIG. 4, where the user seems to view the image in the second playback window through the first playback window.

When the first playing window and the second playing window are displayed in a superimposed manner, the user wears a headset. As the user's head turns or moves, the frame of the VR video changes accordingly as the user's head posture (position and attitude) changes. The first playing window is located at a fixed location in the second playing window, and when the frame within the second playing window changes, the frame within the first playing window changes accordingly. For the user, the first playing window is similar to a viewfinder that follows the user's head movements, and the frames inside the viewfinder change constantly, which can bring an immersive experience to the user in some games or other scenarios.

In S203, in response to a full-screen playing instruction, the first playing window is controlled to disappear, the VR video being played in a full screen within the second playing window after the first playing window disappears.

During displaying the first playing window and the second playing window in a superimposed way, the user may select to display in a full screen within the second playing window according to needs, and the full-screen playing instruction may be input via the user handle, voice or gesture, etc.

Optionally, a full-screen playing control is displayed within the first playing window, and in response to a second operation on the full-screen playing control, the first playing window is controlled to disappear. The second operation may be clicking, double-clicking, or hovering operation.

As an example, the first playing window may be controlled to disappear in the following modes:

In a first mode, in response to the full-screen playing instruction, the first playing window is controlled to disappear instantaneously.

In a second mode, in response to the full-screen playing instruction, the first playing window is controlled to gradually increase until a boundary of the first playing window exceeds a boundary of the second playing window, and then the first playing window disappears, and an area of the VR video displayed within the first playing window gradually increases in the process of increasing the first playing window.

In the first mode, the first playing window disappearing instantaneously is relative to the second mode. In the second mode, the first playing window disappears gradually, and the user can see the dynamic frames of the first playing window disappearing, which brings the user a smoother experience. In the first mode, the first playing window disappears rapidly, and thus the user fails to perceive the disappearance process of the first playing window.

In a third mode, in response to the full-screen playing instruction, the first playing window is controlled to gradually shrink until completely disappearing. During the process of shrinking the first playing window, the area of the VR video displayed within the first playing window reduces gradually.

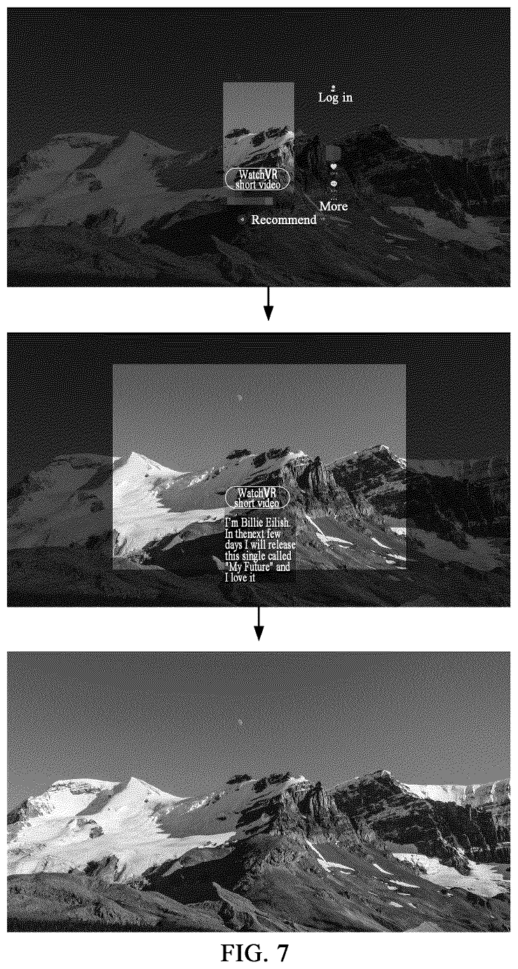

FIG. 7 is a schematic diagram of the interface change of a VR video switching to full-screen playing in the second playback window. As shown in FIG. 7, when the first playing window is displayed in a way of being superimposed on the second playing window, a full-screen playing control is displayed at the bottom of the first playing window: “Watch the VR short video”. After the user clicks the control “Watch the VR short video”, the first playing window gradually increases until a boundary of the first playing window exceeds a boundary of the second playing window, and then the first playing window disappears completely.

In the interface shown in FIG. 7, the following information is displayed inside and/or outside the border of the first playing window: information of a currently displayed video, information of the 2D application, video recommendation information and the full-screen playing control. After the user clicks the full-screen playing control, while the first playing window gradually increases, the transparency of the information inside and/or outside the border of the first playing window reduces gradually until the information disappears.

The information displayed inside and/or outside the first playing window might mask the VR video. Therefore, after switching from the 2D video to the VR video, part or all of the information will be hidden after a first preset time, so that the information can mask the VR video.

In one implementation, after switching from the 2D video to the VR video, the following information is displayed inside and/or outside the border of the first playing window within a first preset time of the start of playing of the VR video: information of the VR video, information of the 2D application, video recommendation information and a full-screen playing control, and after the expiration of the first preset time, the video recommendation information and the full-screen playing control are displayed inside and/or outside the border of the first playing window. That is, all other information than the video recommendation information and the full-screen playing control is hidden, but only the video recommendation information and the full-screen playing control remain, so as to facilitate the full-screen playing and switching the VR video for the user.

In S204, in response to a full-screen exit instruction, the first playing window is displayed in a way of being superimposed on the second playing window.

Where the second playing window plays in a full screen, the user may select to exit the full-screen playing, and then the VR video is played in a way of displaying the first playing window superimposed on the second playing window.

Optionally, a full-screen exit control is displayed in the second playing window. In response to a third operation of the user on the full-screen exit control, the first playing window is controlled to appear and be superimposed on the second playing window. The third operation may be clicking, double-clicking, or hovering operation.

As an example, the first playing window may be controlled to appear in the following modes:

In a first mode, in response to the full-screen exit instruction, the first playing window is controlled to appear instantaneously.

In a second mode, in response to the full-screen exit instruction, based on a target location and target size of the first playing window, the first playing window is controlled to gradually reduce to the target size and the target location from a boundary of the second playing window, and an area of the VR video displayed within the first playing window gradually reduces in a process of reducing the first playing window.

In the first mode, the first playing window appearing instantaneously is relative to the second mode. In the second mode, the first playing window appears gradually, and the user can see the dynamic frames of the first playing window appearing, which brings the user a smoother experience. In the first mode, the first playing window appears rapidly, and thus the user fails to perceive the appearance process of the first playing window.

In a third mode, in response to the full-screen exit instruction, the first playing window is controlled to gradually increase from the target location to the target size. During the process of the first playing window increasing, the area of the VR video displayed within the first playing window increases gradually.

It is to be noted that the full-screen playing instruction and the full-screen exit instruction may be or may not be triggered by the user. For example, it may be configured in advance to play in a full screen or to exit a full screen in a certain scene or mode or at a certain location or anchor, and then the full-screen playing instruction or full-screen exit instruction will be generated accordingly. For example, it is configured in advance to exit the full-screen playing after the user enters a certain space, and to apply the full-screen playing after the user leaves the space.

In this embodiment, when the video after switching in response to the first video switching instruction is a VR video, the first playing window is displayed in a way of being superimposed on the second playing window, and the VR video screen is played within the second playing window, wherein a content of the VR video located within an area covered by the first video playing window is displayed through the first playing window and a remaining content is displayed within the second playing window. The user may, based on own needs, control the first playing window to disappear, display the VR video in a full screen through the second playing window, and after switching to the full-screen display in the second playing window, further exit the full-screen display. Therefore, the VR video is displayed in a way of superimposing the second playing window and the first playing window, and better experience can be brought about to the user.

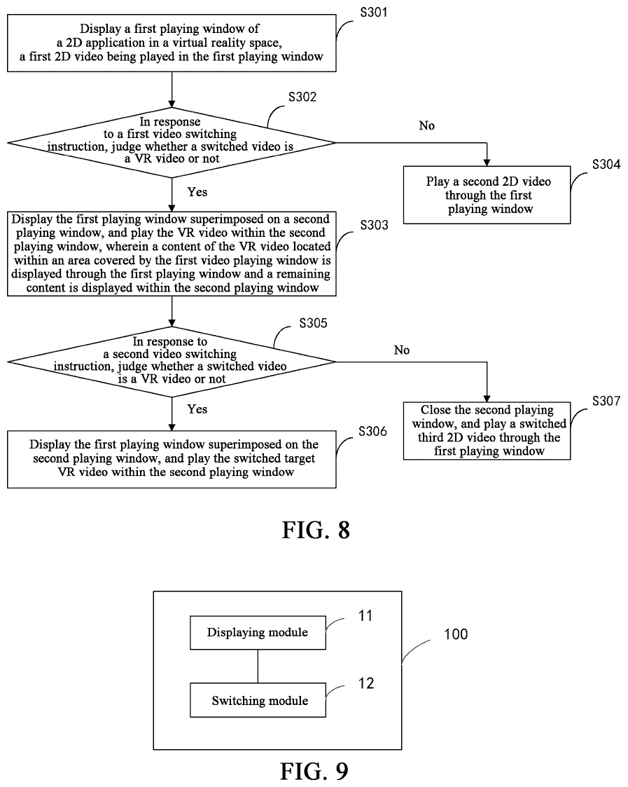

On the basis of the first embodiment and the second embodiment, FIG. 8 is a flowchart of a method for switching video provided by a third embodiment of the present disclosure. As shown in FIG. 8, the method provided in this embodiment comprises the following.

In S301, a first playing window of a D2 application is displayed in a virtual reality space, a first 2D video being played in the first playing window.

In S302, in response to a first video switching instruction, it is judged whether a switched video is a VR video or not.

If yes, the flow proceeds to step S303; if not, the flow proceeds to step S304.

In S303, the first playing window is displayed in a way of being superimposed on a second playing window, and VR video is played within the second playing window, wherein a content of the VR video located within an area covered by the first video playing window is displayed through the first playing window and a remaining content is displayed within the second playing window.

In S304, a second 2D video is played through the first playing window.

When a switched video is a 2D video, the second 2D video after switching continues to be played through the first playing window.

In S305, in response to a second video switching instruction, it is judged whether a switched video is a VR video.

If the switched video is a VR video, the flow proceeds to step S306. If the switched video is not a VR video, the flow proceeds to step S307.

In S306, the first playing window is displayed in a way of being superimposed on the second playing window, and a target VR video after switching is played within the second playing window.

In this embodiment, after switching to the target VR video, the target VR video is displayed in the mode of S306. Of course, when the switched video is determined as a VR video based on the second video switching instruction, the target VR video after switching is played through the second playing window.

In one implementation, the display mode of the VR video remains unchanged before and after switching. That is, if the VR video before switching is displayed by superimposing the first playing window and the second playing window, then after switching the target VR video, the switched target VR video is still displayed by superimposing the first playing window and the second playing window. If the VR video before switching is displayed in a full screen through the second playing window, then after switching to the target VR video, the switched target VR video is still displayed in a full screen through the second playing window.

In another implementation, the display mode of the VR video might change before and after switching. Each time a new VR video is switched to, it is played in a default display mode. For example, the VR video is played in a way of superimposing the first playing window and the second playing window by default. If the user selects a full-screen display of the VR video within the second playback window prior to the switching, after switching to the target VR video, the target VR video is played by superimposing the first playing window and the second playing window.

In S307, the second playing window is closed, and a switched third 2D video is played through the first playing window.

In this embodiment, when the user switches from the 2D video to the VR video, he can still flexibly switch from the VR video to other VR video or 2D video, and thus better experience is brought about to the user.

To better implement the method for switching video in the embodiments of the present disclosure, an embodiment of the present disclosure further provides an apparatus for switching video. FIG. 9 is a structural schematic diagram of an apparatus for switching video provided by a fourth embodiment of the present application. As shown in FIG. 9, the apparatus 100 for switching video may comprise:
a displaying module 11 configured to display a first playing window of a 2D application in a virtual reality space, a first 2D video being played in the first playing window; and
a switching module 12 configured to determine a switched video as a virtual reality VR video in response to a first video switching instruction, and play the VR video through a second playing window, wherein the second playing window has a larger area than the first playing window.

In some embodiments, the switching module 12 is specifically configured to:
display the VR video in a full screen within the second playing window.

In some embodiments, the switching module 12 is specifically configured to:
display the first playing window superimposed on the second playing window, and play the VR video screen within the second playing window, wherein a content of the VR video located within an area covered by the first video playing window is displayed through the first playing window and a remaining content is displayed within the second playing window, and the second playing window has a less transparency than the first playing window.

In some embodiments, the switching module 12 is specifically configured to:
generate a masked image based on a location and a size of the first playing window, an effective area of the masked image being an area corresponding to the first playing window, an image within the effective area being fully displayed, and an image outside the effective area being displayed semi-transparently; and
display the VR video played within the second playing window after superimposing the masked image and the second playing window.

In some embodiments, the switching module 12 is specifically configured to:
in response to a first operation on the recommendation control for VR videos, determine the switched video is a virtual reality VR video, and play the VR video through the second playing window.

In some embodiments, there is further comprised:
a playing control module configured to, in response to a full-screen playing instruction, control the first playing window to disappear, the VR video being played in a full screen within the second playing window after the first playing window disappears.

In some embodiments, a full-screen playing control is displayed within the first playing window, and the playing control module is specifically configured to:
in response to a second operation on the full-screen playing control, control the first playing window to disappear.

In some embodiments, the playing control module is specifically configured to:
control the first playing window to gradually increase until a boundary of the first playing window exceeds a boundary of the second playing window, and then the first playing window disappearing, and an area of the VR video displayed within the first playing window gradually increasing in the process of increasing the first playing window.

In some embodiments, there is further comprised:
a playing control module configured to display the first playing window superimposed on the second playing window in response to a full-screen exit instruction.

In some embodiments, a full-screen exit control is displayed within the second playing window, and the playing control module is specifically configured to:
control the first playing window to appear and to be superimposed on the second playing window in response to a third operation on the full-screen exit control.

In some embodiments, the playing control module is specifically configured to:
in response to the full-screen exit instruction, based on a target location and target size of the first playing window, control the first playing window to gradually reduce to the target size and the target location from a boundary of the second playing window, and an area of the VR video displayed within the first playing window gradually reducing in a process of reducing the first playing window.

In some embodiments, there is further comprised:
a shape transformation module configured to transform a shape of the first playing window in response to a shape transformation operation on the first playing window.

In some embodiments, the following information is displayed inside and/or outside a border of the first playing window: information of a currently displayed video, information of the 2D application and video recommendation information.

In some embodiments, the following information is displayed inside and/or outside a border of the first playing window within a first preset time of the start of playing of the VR video: information of the VR video, information of the 2D application, video recommendation information and a full-screen playing control, and after the expiration of the first preset time, the video recommendation information and the full-screen playing control are displayed inside and/or outside the border of the first playing window.

In some embodiments, the switching module 12 is further configured to:
determine a switched video as a second 2D video in response to the first video switching instruction, and play the second 2D video through the second playing window.

In some embodiments, the switching module 12 is further configured to:
determine a switched video as a VR video in response to a second video switching instruction, and play a switched target VR video through the second playing window.

In some embodiments, the switching module 12 is further configured to:
determine a switched video as a 2D video in response to a second video switching instruction, and close the second playing window, and play a switched third 2D video through the first playing window.

It should be understood that the apparatus embodiments may correspond to the method embodiments, and similar description may be referred to the method embodiments and is not repeated here.

The apparatus 100 of the embodiments of the present application has been described above from the perspective of functional modules in conjunction with the accompanying drawings. It should be understood that the functional modules may be implemented in hardware, software instructions or a combination of hardware and software modules. Specifically, various steps of the method embodiments in the present application may be accomplished by integrated logic circuits of hardware in the processor and/or instructions in the form of software, and the steps of the method disclosed in conjunction with the embodiments of the present application may be directly embodied as being performed by a hardware decoding processor, or performed with a combination of hardware and software modules in a decoding processor. Optionally, the software modules may be located in random memory, flash memory, read-only memory, programmable read-only memory, electrically erasable programmable memory, a register, and other storage medium well established in the art. The storage medium is located in a memory, and a processor reads information in the memory to perform the steps of the foregoing method embodiments in conjunction with hardware.

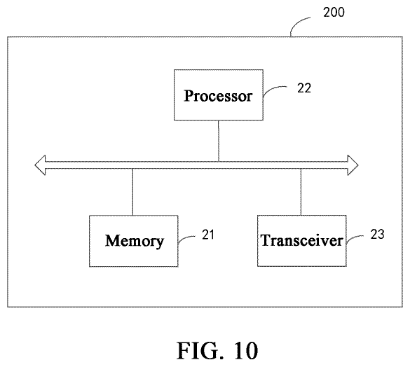

An embodiment of the present application further provides an electronic device. FIG. 10 is a structural schematic diagram of an electronic device provided by a fifth embodiment of the present application. As shown in FIG. 10, the electronic device 200 may comprise:
a memory 21 and a processor 22, the memory 21 configured to store a computer program and transmit the program code to the processor 22. In other words, the processor 22 may call the computer program from the memory 21 and run the same to implement the method in the embodiments of the present application.

For example, the processor 22 may be configured to implement the foregoing method embodiments based on instructions in the computer program.

In some embodiments of the present application, the processor 22 may include, but is not limited to:
a general-purpose processor, a digital signal processor (DSP), an application specific integrated circuits (ASIC), a field programmable gate array (FPGA), or other programmable logic device, a discrete gate or a transistor logic device, a discrete hardware component and the like.

In some embodiments, the memory 21 includes, but is not limited to:
volatile memory and/or non-volatile memory, wherein the non-volatile memory may be read-only memory (ROM), programmable ROM (PROM), erasable PROM (EPROM), electrically EPROM (EEPROM) or flash memory, and the volatile memory may be random access memory (RAM) that is used as an external cache. By way of illustration, but not limitation, many forms of RAM are available, such as static RAM (SRAM), dynamic RAM (DRAM), synchronous DRAM (SDRAM), double data rate SDRAM (DDR SDRAM), enhanced SDRAM (ESDRAM), synch link DRAM (SLDRAM), and direct Rambus RAM (DRAM).

In some embodiments of the present application, the computer program may be partitioned into one or more modules, the one or more modules being stored in the memory 21 and executed by the processor 22 to accomplish the method provided in the present application. The one or more modules may be a series of computer program instruction segments capable of accomplishing specific functions, the instruction segments describing a process of executing the computer program in the electronic device.

As shown in FIG. 10, the electronic device may further comprise: a transceiver 23, connectable to the processor 22 or the memory 21.

The processor 22 may control the transceiver 23 to communicate with other device, specifically, to send information or data to other device or receive information or data sent by other device. The transceiver 23 may comprise a transmitter and a receiver. The transceiver 23 may further comprise antennas, and the number of antennas may be one or more.

It should be understood that the electronic device 200, though not shown in FIG. 10, may further comprise a camera module, a wireless fidelity WIFI module, a positioning module, a Bluetooth module, a display, a controller and the like, which will not be further described herein.

It should be understood that various components in the electronic device are connected via a bus system, wherein the bus system further comprises a power bus, a control bus and a status signal bus, besides a data bus.

The present application further provides a computer storage medium, storing a computer program thereon, wherein the computer program, when executed by a computer, causes the computer to perform the method in the foregoing method embodiments. Or an embodiment of the present application further provides a computer program product containing instructions which, when executed by a computer, cause the computer to perform the method in the foregoing method embodiments.

The present application further provides a computer program product, comprising a computer program which is stored in a computer readable storage medium. The processor of the electronic deice reads the computer program from the computer readable storage medium, and then executes the computer program to cause the electronic device to perform a corresponding flow of a control method for a user location in a virtual scene in the embodiments of the present application, which is not repeated here for the sake of brevity.

It should be understood that the systems, apparatuses and methods disclosed in several embodiments provided by the present application may be implemented in other way. For example, the apparatus embodiment described above is merely illustrative, for example, the division of the module is only a logical functional division, and other division mode may further exist in the actual implementation. For example, a plurality of modules or components can be combined or can be integrated into another system, or some features can be ignored, or not implemented. In addition, the mutual coupling, direct coupling or communication connection as shown or discussed may be indirect coupling or communication connection through some interface, apparatuses or modules, which may be electrical, mechanical or otherwise.

Modules illustrated as separated components may or may not be physically separated, and components shown as modules may or may not be physical modules, i.e., they may be located in a single place or they may also be distributed over a plurality of network units. Some or all of these modules may be selected to fulfill the purpose of the solution of the embodiments according to actual needs. For example, various functional modules in various embodiments of the present application may be integrated in one processing module, or respective modules may physically exist separately, or two or more modules may be integrated in one module.

The specific implementations of the present application have been described above. However, the protection scope of the present application is not limited thereto. Any variations or replacements readily conceivable by those skilled in the art within the technical scope disclosed in the present application shall be covered by the protection scope of the present application. Therefore, the protection scope of the present application should be based on the protection scope of the claims.

I/We claim:

1. A method for switching video, comprising:
displaying a first playing window of a 2D application in a virtual reality space, a first 2D video being played in the first playing window; and
in response to a first video switching instruction, determining a switched video as a virtual reality (VR) video, and playing the VR video through a second playing window, the second playing window having a larger area than the first playing window.

2. The method of claim 1, wherein playing the VR video through the second playing window comprises:
displaying the VR video in a full screen within the second playing window.

3. The method of claim 1, wherein playing the VR video through the second playing window comprises:
superimposing and displaying the first playing window on the second playing window, and playing the VR video within the second playing window, wherein a content of the VR video located within an area covered by the first video playing window is displayed through the first playing window and a remaining content is displayed within the second playing window, and the second playing window has a less transparency than the first playing window.

4. The method of claim 3, wherein superimposing and displaying the first playing window on the second playing window comprises:
generating a masked image based on a location and a size of the first playing window, an effective area of the masked image being an area corresponding to the first playing window, an image within the effective area being displayed completely, and an image outside the effective area being displayed semi-transparently; and
displaying the VR video played within the second playing window after superimposing the masked image and the second playing window.

5. The method of claim 1, wherein a recommendation control for a VR video is further displayed in the virtual reality space, and in response to the first video switching instruction, determining the switched video as the VR video and playing the VR video through the second playing window comprises:
in response to a first operation on the recommendation control for the VR video, determining the switched video is the VR video, and playing the VR video through the second playing window.

6. The method of claim 3, further comprising:
in response to a full-screen playing instruction, controlling the first playing window to disappear, the VR video being played in a full screen within the second playing window after the first playing window disappears.

7. The method of claim 6, wherein a full-screen playing control is displayed within the first playing window, and in response to the full-screen playing instruction, controlling the first playing window to disappear comprises:
in response to a second operation on the full-screen playing control, controlling the first playing window to disappear.

8. The method of claim 6, wherein controlling the first playing window to disappear comprises:
controlling the first playing window to gradually increase until a boundary of the first playing window exceeds a boundary of the second playing window, and the first playing window disappearing, wherein an area of the VR video displayed within the first playing window gradually increases in the process of increasing the first playing window.

9. The method of claim 6, further comprising:
in response to a full-screen exit instruction, superimposing and displaying the first playing window on the second playing window.

10. The method of claim 9, wherein a full-screen exit control is displayed within the second playing window, and in response to the full-screen exit instruction, superimposing and displaying the first playing window on the second playing window comprises:
in response to a third operation on the full-screen exit control, controlling the first playing window to appear and to be superimposed on the second playing window.

11. The method of claim 9, wherein in response to the full-screen exit instruction, superimposing and displaying the first playing window on the second playing window comprises:
in response to the full-screen exit instruction, controlling, based on a target location and a target size of the first playing window, the first playing window to gradually reduce to the target size and the target location from a boundary of the second playing window, wherein an area of the VR video displayed within the first playing window gradually reduces in a process of reducing the first playing window.

12. The method of claim 3, further comprising:
in response to a shape transformation operation on the first playing window, transforming a shape of the first playing window.

13. The method of claim 1, wherein the following information is displayed on an inner and/or outer border of the first playing window: information of a currently displayed video, information of the 2D application and video recommendation information.

14. The method of claim 3, wherein the following information is displayed on an inner and/or outer border of the first playing window within a first preset time from the start of playing of the VR video: information of the VR video, information of the 2D application, video recommendation information and a full-screen playing control; and the video recommendation information and the full-screen playing control are displayed on an inner and/or outer border of the first playing window after the first preset time finishes.

15. The method of claim 1, further comprising:
in response to the first video switching instruction, determining a switched video as a second 2D video, and playing the second 2D video through the second playing window.

16. The method of claim 1, further comprising:
in response to a second video switching instruction, determining a switched video as a VR video, and playing a switched target VR video through the second playing window.

17. The method of claim 3, further comprising:
in response to a second video switching instruction, determining a switched video as a 2D video, and closing the second playing window, and playing a switched third 2D video through the first playing window.

18. An electronic device, comprising:
a processor; and
a memory, the memory storing a computer program, wherein the processor is configured to invoke and run the computer program stored in the memory to cause the electronic device to:
display a first playing window of a 2D application in a virtual reality space, a first 2D video being played in the first playing window; and
in response to a first video switching instruction, determine a switched video as a virtual reality (VR) video, and play the VR video through a second playing window, the second playing window having a larger area than the first playing window.

19. The electronic device of claim 1, wherein playing the VR video through the second playing window comprises:
displaying the VR video in a full screen within the second playing window.

20. A computer program product comprising a computer program, wherein the computer program is stored on a non-transitory machine-readable medium, the computer program when executed by a processor, causes the processor to:
display a first playing window of a 2D application in a virtual reality space, a first 2D video being played in the first playing window; and
in response to a first video switching instruction, determine a switched video as a virtual reality (VR) video, and play the VR video through a second playing window, the second playing window having a larger area than the first playing window.
